(19) United States
(12) Patent Application Publication
(10) Pub. No.: US 2007/0211949 A1
(43) Pub. Date: Sep. 13, 2007

(54) Two-Dimensional Adaptive Image Compression Method

(76) Inventor: Juergen NEUMANN, Karlsruhe (DE)

Correspondence Address: BEEM PATENT LAW FIRM, 53 W. JACKSON BLVD., SUITE 1352, CHICAGO, IL, 60604-3787, US

(21) Appl. No.: 11/683,621

(22) Filed: Mar. 8, 2007

(30) Foreign Application Priority Data
Mar. 9, 2006 (DE) 10 2006 011 022.6

(51) Int. Cl. G06K 9/36

(52) U.S. Cl. 382/239

(57) ABSTRACT

According to the invention, a method is provided for the compression of data which contain a plurality of information units, comprising: determining of one or more expected values for each of the information units; for each information unit, determining a coincidence of the value of the information unit with the one or more expected values; and producing output data which contain information concerning the coinciding of the values of the information units with the one or more expected values, and information concerning the values of the information units, if non-coincidences with the one or more expected values are found, in which the expected values are formed on the basis of values of information units which have already been subjected to the preceding steps for compression and form a two-dimensional context with respect to the present information unit.

This application claims the benefit of priority of German Patent Application 10 2006 011 022.6 filed on Mar. 9, 2006.

### DESCRIPTION

The present invention relates to a method for the compression of data, and in particular a two-dimensional adaptive image compression method.

### BACKGROUND OF THE INVENTION

Known lossless image compression methods (e.g. GIF; PNG) are based on two compression principles:
entropy coding (e.g. Huffmann coding, arithmetic coding)
string replacement coding (e.g. run length coding, LZ77, L278).

It is also known to combine these two compression principles with each other.

In known string replacement methods the (originally two-dimensional) image is coded as a one-dimensional pixel string, which in turn is coded pixel for pixel. The local context which can be used for the compression of a pixel hereby consists merely of the pixels lying immediately to the left of the pixel which is just processed.

In the known run length coding, only horizontal “runs” of isochromatic pixels are recognized. Thereby, an image which consists of horizontal stripes is compressed

substantially better than an image which consists of vertical stripes.

The same restrictions apply for all “one-dimensional” string replacement methods.

There is a general concern in the lossless compression of data, particularly image data, to achieve as high a compression rate as possible, i.e. an image which is to be compressed is to be described by as few data as possible.

With this background, it is an object of the invention to increase the compression rate compared with known methods, without requiring a substantially greater calculation effort in the compression/decompression.

### SUMMARY OF THE INVENTION

This problem is solved by the invention indicated in the main claims. Advantageous embodiments are indicated in the subclaims.

In particular the invention is based on the knowledge that by means of the use of expected values, which are formed with the aid of a two-dimensional “compression context”, the compression rate can be increased, compared with known “one-dimensional” methods.

### DESCRIPTION OF EXAMPLE EMBODIMENTS

The present invention will now be explained with the aid of example embodiments with reference to the drawings, in which:

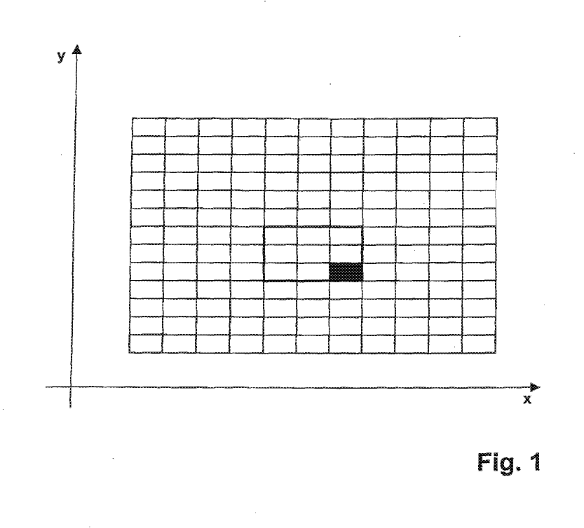

FIG. 1 shows diagrammatically a two-dimensional pixel grid, to which the method according to the invention is able to be applied;

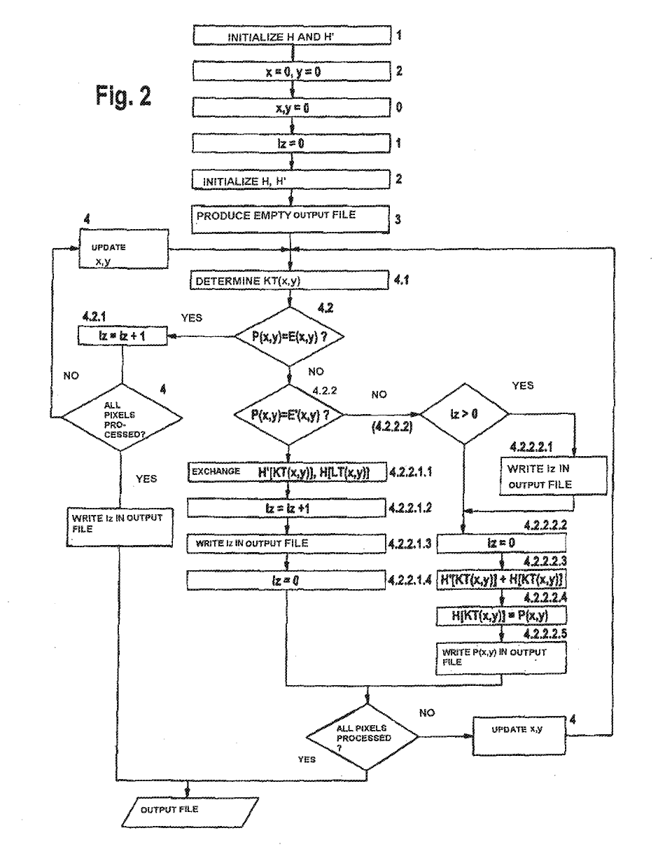

FIG. 2 shows a flow diagram which illustrates the individual steps of a compression method according to an embodiment of the invention; and

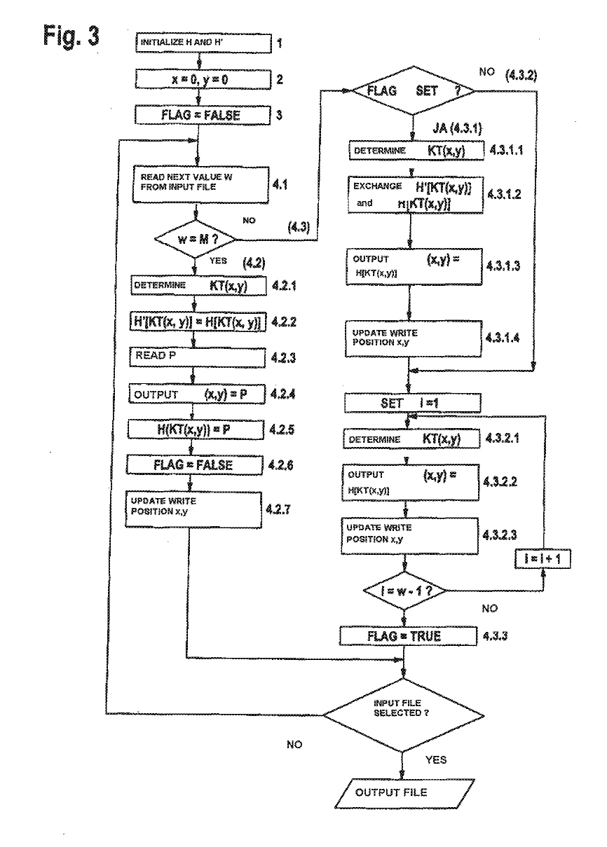

FIG. 3 shows a flow diagram which illustrates the individual steps of a decompression method according to an embodiment of the invention

FIG. 1 shows a two-dimensional pixel grid, to which the compression method according to the present invention is able to be applied. According to the compression method, a “context value” is formed for each pixel, which is based on the values of a predetermined parameter (e.g. colour, brightness etc.) of specific preceding pixels in two dimensions. In FIG. 1, one of the pixels is shown in black. To determine the context value of this pixel! the values of pixels are used which are no further than two pixels distant towards the x- or y-direction, i.e. the values of all pixels within the indicated marking.

The range of the context under consideration, i.e. the number of pixels to be taken into consideration towards the x- and y-direction can be determined differently depending on the application. Also, the “context form” resulting therefrom can vary—this may, for example, be circular.

The context values are used to determine expected values, as described below with reference to FIG. 2.

With reference to FIG. 2, the steps of a compression method according to a development of the invention will now be described:
0. Setting the pixel coordinates x and y to 0.
1. Initializing a run length counter lz, i.e. setting lz to 0.
2. Initializing first and second hash tables H and H′ (with respectively maxhash entries, see below) and setting all entries of both hash tables to the colour value 0.
3. Producing an empty output file.
4. Carrying out the following steps for the colour value of each pixel P(x,y) of the image which is to be compressed:
   4.1 Calculating a compression context KT(x,y)
      The compression contact results here from a two-dimensional environment of the pixel:
         KT(x,y):=f(P(x−2,y−2), P(x−1,y−2), P(x,y−2), P(x−2,y−1), P(x−1,y−1), P(x,y−1), P(x−2,y), P(x−1,y))
      The function f has the characteristics of a test sum function with values between 0 and maxhash−1.
      For this, the definition is: with x<0 or y<0:
         P(x,y)=0.
      This concerns the calculation of the compression context of pixels at the left and at the upper image edge. The image is accordingly extended to the left and upwards by two rows and two columns of “imaginary” black pixels.
      The method according to the invention is, however, not restricted to a compression context of the range 2/2; rather, other ranges can also be used. All the pixels contained in the context have been transferred before the actual pixel (i.e. subjected to compression).
      If the pixels are processed in different sequence than described here (from left to right and from top to bottom), then the compression context is adapted accordingly.
   4.2 Comparing the actual colour value P(x,y) of the pixel with an expected value E(x,y) for the colour value, in which the expected value results as:
      E(x,y):=H[KT(x,y)]
      4.2.1 If the actual colour value corresponds to the expected value:
         Increasing the run length counter lz by 1.
      4.2.2 Otherwise: Comparing the actual colour value P(xy) with the second expected value E′(x,y), in which the second expected value results as:
         E′(x,y):=H′[KT(x,y) ]
         4.2.2.1 If the actual colour value corresponds to the second expected value: Carrying out the following steps:
         4.2.2.1.1 Reciprocal exchange of the values H′[KT(x, y)] and H[KT(x,y)].
         4.2.2.1.2 Increasing the run length value lz by 1.
         4.2.2.1.3 Writing the run length value lz into the source file.
         4.2.2.1.4 Resetting the run length value lz to 0.
         4.2.2.2 Otherwise: Carrying out the following steps:
         4.2.2.2.1 With lz>0: Writing the run length value lz into the source file.
         4.2.2.2.2 Resetting the run length value lz to 0.
         4.2.2.2.3 Replacing the second expected value H′[KT(x,y)] by the first expected value H[KT(x,y)]
            H′[KT(x,y)]:=H[KT(x,y)]
         4.2.2.2.4 Storing the actual colour value as new expected value:
            H[KT0x,y)]:=P(x,y)
         4.2.2.2.5 Writing the colour value P(x,y) into the source file, provided with a clear mark M. The mark M serves for the differentiation of run lengths and colour values in the source file. In particular a colour value always precisely follows the mark M.

The above-mentioned steps (apart from the initializing) are repeated for all the pixels of the image which is to be compressed.

When all the pixels have been processed and if the colour value of the last pixel corresponded to the first expected value E(x,y) , then finally the run length counter lz is increased by 1 and is transferred into the output file.

Instead of step 4.2.2.2.5, a lookup in a cashing table of the last written colours can take place, and (if successful) only the corresponding cash index can be written. The colour cash table is then updated accordingly.

The output file can then be further “subsequently compressed” with an entropy coder (e.g. Huffman method).

In carrying out the compression method, the following is brought about: For each pixel whose colour value P(x,y) corresponds to the current (first) expected value E(x,y), the run length lz is increased by one. If the colour value P(x,y) no longer corresponds to the first expected value E(x,y), but instead corresponds to the previous (second) expected value E′(x,y), then the run length lz is increased by one, is written into the output file and is then reset. In addition, the hash tables H and H′ are updated, i.e. the first (no longer applicable) expected value E(x,y) contained in the first hash table H and the second (now applicable) expected value E′(x,y) contained in the second hash table H′, are reciprocally exchanged.

As the (current and previous) expected values are known on the receiver side, colour values coinciding therewith do not have to be written into the source file. A transition from a colour value which corresponds to the current (first) expected value to a colour value which corresponds to the previous (second) expected value, is recognized on the receiver side by means of two successive run length values in the source file.

Only a new, “unexpected” colour value has to be written into the output file.

This can be illustrated by means of a simple example. In this example, “A” stands for pixels with a colour value which corresponds to the current expected value. “B” stands for pixels with a colour value which corresponds to the previous expected value. “C” stands for a pixel with a new. unexpected colour value. An example pixel sequence now reads

### AAAAABAAAAC

For each pixel A, the run length is increased by one. On reaching pixel B, the run length accordingly amounts to 5. The run length is then further increased by one to 6, is written into the output file and is reset to zero. The run length is then again increased by one for each pixel A. On reaching the pixel C, the run length amounts to 4 and is written into the source file. As the pixel C has an unexpected colour value, the latter is likewise written into the output file (provided with the mark M). The content of the output file is therefore

### 64MC

The hash tables described above are identical at the start of compressing on the transmitter and on the receiver side. Proceeding therefrom, the hash tables are updated both on the transmitter side and on the receiver side depending on the sequence of the transferred or received pixel information in accordance with the algorithm described above. By means of the hash tables, the pixel sequence can then be reconstructed on the receiver side by means of the content of the source file.

From the content of the source file it can therefore be determined that following 5 pixels with a colour value (A) corresponding respectively to the first expected value there is 1 pixel with a colour value (B) corresponding to the second expected value, followed by 4 pixels which respectively have a colour value corresponding to the (new) first expected value, followed by one pixel with a new colour value (C) . It is to be noted that successive pixels whose colour value corresponds respectively to an expected value, do not inevitably have the same colour value—rather each Pixel has an expected colour value.

The steps of a method for the decompression of a output file (hereinbelow “input file”) produced according to the compression method described above on the receiver side are described below with reference to FIG. 3:
1. Initializing of first and second hash tables H and H′ (with respectively maxhash entries, see above) and setting all entries of both hash tables to the colour value 0.
2. Setting the actual write position to (x=0; y=0).
3. Setting a flag:
   flag:=FALSE
4. opening the input file and carrying out the following steps, until the end of the input file is reached:
   4.1 Reading a value w from the input file.
   4.2 If w corresponds to the mark M: carrying out the following steps:
      4.2.1 Calculating the compression context KT(x,y)
         (The compression context is calculated on the receiver side by means of the pixel values already written into an output file Output [x,y], in an analogous manner to the calculation of the compression context on the receiver side, see above).
      4.2.2. Replacing the second expected value H′[KT(x,y)] by the first expected value H[KT (x,y)]
         H′[KT(x,y)]:=KT(x,y)]
      4.2.3 Reading the colour value P from the input file (follows the mark M)
      4.2.4 Setting the pixel at the actual position (x,y) of the output file to the value P
         Output[x,y]:=P
      4.2.5 inheriting the actual colour value as new expected value:
         H[KT(x,y)]:=P
      4.2.6 Resetting the flag:
         Flag:=FALSE
      4.2.7 Updating the actual write position (x,y):
         if x<image width then x:=x+1 otherwise (x:=0; y:=y+1)
   4.3 Otherwise carrying out the following steps:
      4.3.1 When the flag is set: Carrying out the following steps:
         4.3.1.1 Calculating the compression context KT(x, y)
         4.3.1.2 Reciprocal exchange of values H′[KT(x,y)] and H[KT(x,y)]
         4.3.1.3 Setting the pixel at the actual position (x,y) in the output file to the expected value H[KT(x,y)]
            Output[x,y]:=H[KT(x,y)]
         4.3.1.4 Updating the actual write position (x,y):
         if x<image width then x:=x+1 otherwise (x:=0; y:=y+1)
      4.3.2 Otherwise repeating the following steps w−1 times:
         4.3.2.1 Calculating the compression context KT (x,y)
         4.3.2.2 Setting the pixel at the actual position (x,y) in the output file to the expected value H[KT(x,y)]
            Output[x,y]:=H[KT(x,y)]
         4.3.2.3 Updating the actual write position (x,y)
         if x<image width then x:=x+1 otherwise (x:=0; y:=y+1)
      4.3.3 Setting the flag:
         flag:=TRUE

It is to be noted that the method is not restricted to a particular representation of the colour value of a pixel. For example, the colour values can be represented as R,G,B triples or (in monochrome images) a an individual brightness value.

1. A method for the compression of data which contain a plurality of information units, in which the method for a present one of the plurality of information units comprises the following steps:
(A) comparing the value of a predetermined parameter of the present information unit with a first expected value; and if they coincide:
(a) increasing the value of a counter; or if they do not coincide:
(b) comparing the value of the predetermined parameter of the present information unit with a second expected value; and if they coincide:
(aa) increasing the counter value and
(ab) transferring the counter value into an output file or if they do not coincide:
(ba) transferring the counter value into the output file, if the counter value is greater than zero; and
(bb) transferring the value of the predetermined parameter of the present information unit into the output file.

2. The method according to claim 1, in which the first and the second expected values are formed on the basis of values of information units which have already been subjected to the preceding steps for compression.

3. The method according to claim 1, in which the first and the second expected values are formed on the basis of values of information units which form a two-dimensional context with regard to the present information unit.

4. The method according to claim 1, comprising:
forming a context value with respect to the present information unit by determining the value of the predetermined parameter of information units which have already been subjected to the preceding steps for compression;
running first and second hash tables, in which an entry in the first and in the second hash table is associated with every possible context value, and in which the first and second expected values are formed by entries in the first or second hash table, which are associated with the context value.

5. The method according to claim 4, in which when the value of the predetermined parameter of the present information unit coincides with a second expected value, an adaptation of the first and second expected values is carried out by reciprocal exchange of the corresponding entries in the first or second hash table.

6. The method according to claim 1, in which when the value of the predetermined parameter of the present information unit coincides with the second expected value, a resetting of the counter value is carried out.

7. The method according to claim 4, in which when the value of the predetermined parameter of the present information unit does not coincide with the second expected value, an adaptation of the first and second expected values is carried out by the following steps:
replacing the entry corresponding to the second expected value in the second hash table by the entry corresponding to the first expected value in the first hash table; and
replacing the entry corresponding to the first expected value in the first hash table by the value of the specified parameter of the present information unit.

8. The method according to claim 1, comprising:
repeating the steps for all the information units, in which, if for the last of the information units step (a) was carried out, a transfer of the counter value into the output file takes place.

9. The method according to claim 8,
in which at the start of carrying out the method, the first and second hash tables are initialised for all information units, and
in which the counter value is set to zero.

10. A method for the decompression of data in an input file, which have been compressed by the method according to any of the preceding claims, comprising:
selecting a value from the input file; and
if the selected value is a value of the predetermined parameter, associating the value to an actual information unit intended for output.

11. The method according to claim 10, comprising:
forming a context value with respect to the actual information unit on the basis of values which have been associated with already preceding information units intended for output; and
running third and fourth hash tables, in which an entry in the third and in the fourth hash table is associated with every possible context value.

12 . The method according to claim 11, comprising, if the selected value is a value of the predetermined parameter of an information unit:
replacing the entry associated with the context value with respect to the actual information unit in the fourth hash table by the correspondingly associated entry in the third hash table; and
replacing the entry associated with the context value with respect to the actual information unit in the third hash table by the value associated with the actual information unit.

13. The method according to claim 11, comprising, if the selected value is not a value of the predetermined parameter, and if an auxiliary provided flag is set:
reciprocal exchanging of the values associated with the context value with respect to the actual information unit in the third and fourth hash table; and
associating the value associated with the context value with respect to the actual information unit in the third hash table to the actual information unit.

14. The method according to claim 13, comprising:
associating the value associated with the context value with respect to the actual information unit in the third hash table to the actual information unit.

15. The method according to claim 11, comprising, if the selected value is not a value of the predetermined parameters and if an auxiliary provided flag is not set:
associating the value associated with the context value with respect to the actual information unit in the third hash table to the actual information unit.

16. The method according to claim 12, comprising a resetting of the auxiliary flag.

17. The method according to claim 13, comprising a setting of the auxiliary flag.

18. The method according to claim 11, comprising a repeating of the steps for all the values of the input file.

19. The method according to claim 18,
in which at the start of carrying out the method the third and fourth hash tables are initialised for all information units, and
in which the auxiliary flag is reset.

20. The method according to claim 10, in which the information units are formed by pixels of an image.

21. The method according to claim 20, in which the predetermined parameter is formed by the pixel colour.

22. The method according to claim 3, in which the two-dimensional context is formed by pixels of an image which are adjacent or close in the x- and y-direction.

23. A method for the compression of data, which contain a plurality of information units, comprising:
determining of one or more expected values for each of the information units;
for each information unit, determining a coincidence of the value of the information unit with the one or more expected values; and
generating output data which contain information concerning coincidences of the values of the information units with the one or more expected values, and also information concerning the values of the information units, if non-coincidences with the one or more expected values are found, in which the expected values are formed on the basis of values of information units which have already been subjected to the preceding steps for compression and form a two-dimensional context with respect to the present information unit.

24. A method for the decompression of data, comprising:
Receiving input data which correspond to the output data of the method according to claim 23;
Determining the values of at least a part of the plurality of information units with the aid of information concerning coincidences of the values with one or more expected values, in which the expected values are formed on the basis of values of information units which have already been subjected to the preceding steps for decompression and form a two-dimensional context with respect to the present information unit.

25. The method according to claim 23, in which the information units are formed by pixels of a two-dimensional image, and the two-dimensional context is formed by pixels in both image dimensions (x,y).

26. A data processing device which is adapted to carry out the method according claim 1.

27. A program comprising machine-readable instructions to carry out the method according to claims 1 on a data processing device.

28. A memory medium with a machine-readable program according to claim 27 stored thereon.
